(19) United States
(12) Patent Application Publication
(10) Pub. No.: US 2026/0012068 A1
(43) Pub. Date: Jan. 8, 2026

(54) STEPPER MOTOR

(71) Applicant: AAC Microtech (Changzhou) Co., Ltd., Changzhou City (CN)

(72) Inventors: Lubin Mao, Changzhou (CN); Tong Zhang, Changzhou (CN); Wei Song, Changzhou (CN)

(21) Appl. No.: 18/984,921

(22) Filed: Dec. 17, 2024

Related U.S. Application Data
(63) Continuation of application No. PCT/CN2024/103049, filed on Jul. 2, 2024.

(51) Int. Cl. H02K 37/14

(52) U.S. Cl. CPC H02K 37/14

(57) ABSTRACT

The present disclosure provides a stepper motor, which belongs to the field of motor technology. The stepper motor includes: a rotor assembly including a rotatory shaft and a plurality of magnetic steels arranged along circumference of the rotatory shaft; and one or more stator assemblies stacked along an axial direction of the rotor assembly. Each stator assembly is sleeved on the rotor assembly and includes a respective claw pole assembly arranged around circumference of the rotor assembly, a respective plurality of solenoids arranged along circumference of the respective claw pole assembly, and a respective housing configured to accommodate the respective claw pole assembly and the respective plurality of solenoids. Each solenoid includes a respective iron core and a respective coil wound on the respective iron core, and a central axis of the respective coil extends along a radial direction of the rotatory shaft.

### CROSS REFERENCE TO RELATED APPLICATIONS

The present application is a continuation of PCT Patent Application No. PCT/CN2024/103049, filed Jul. 2, 2024, which is incorporated by reference herein in its entirety.

### TECHNICAL FIELD

The present disclosure relates to the field of motor technology, and in particular to a stepper motor.

### BACKGROUND

The motors are electromagnetic devices used to convert or transmit electrical energy, and are mainly composed of stators and rotors. The stepper motors, as special motors, belong to control motors and are used to convert electrical pulse signals into corresponding angular displacements or linear displacements. At present, in technologies of stepper motors, an axis of coils inside a motor usually coincides with an axis of the motor. However, a radial size of the motor is limited by the thicknesses of walls of the coils, of claw poles, and of magnetic steel, making it difficult to reduce the radial size of the motor, which is not conducive to achieving lightweight and compact motors.

Therefore, it is necessary to provide a new technical solution to address the above-mentioned technical problem.

### SUMMARY

The present disclosure aims to address the technical problem that it is difficult to reduce the radial sizes of motors, thereby being not conducive to achieving lightweight and compact motors.

To this end, the present disclosure provides a stepper motor including: a rotor assembly including a rotatory shaft and a plurality of magnetic steels arranged along circumference of the rotatory shaft; and one or more stator assemblies stacked along an axial direction of the rotor assembly, where each stator assembly of the one or more stator assemblies is sleeved on the rotor assembly and includes a respective claw pole assembly arranged around circumference of the rotor assembly, a respective plurality of solenoids arranged along circumference of the respective claw pole assembly, and a respective housing configured to accommodate the respective claw pole assembly and the respective plurality of solenoids, and where each solenoid of the respective plurality of solenoids includes a respective iron core and a respective coil wound on the respective iron core, and a central axis of the respective coil extends along a radial direction of the rotatory shaft.

As an improvement, the respective claw pole assembly includes two first claw pole portions arranged around the circumference of the rotor assembly and a second claw pole portion arranged around the circumference of the rotor assembly, the second claw pole portion is arranged between the two first claw pole portions, and the two first claw pole portions are connected to the respective housing; and the respective iron core has a first end in contact with the second claw pole portion and a second end in contact with an inner wall of the respective housing.

As an improvement, the respective housing includes a top casing and a bottom casing arranged opposite to each other and further includes a lateral casing connecting the top casing and the bottom casing, and where a top central hole configured for passing through by the rotor assembly is defined on the top casing, a bottom central hole configured for passing through by the rotor assembly is defined on the bottom casing, one of the two first claw pole portions is connected to an inner periphery of the top central hole, and an other of the two first claw pole portions is connected to an inner periphery of the bottom central hole.

As an improvement, each stator assembly of the one or more stator assemblies includes two respective solenoids arranged to be in axial symmetry relative to the rotatory shaft.

As an improvement, the lateral casing includes a first lateral casing and a second lateral casing arranged opposite to each other, one of the two respective solenoids is connected to the first lateral casing, and an other of the two respective solenoids is connected to the second lateral casing; and each of an outer wall of the first lateral casing and an outer wall of the second lateral casing is planar or arcuate.

As an improvement, the respective coil has an arcuate inner wall facing the respective claw pole assembly and an arcuate outer wall facing the lateral casing, and each of a central axis of the arcuate inner wall of the respective coil facing the respective claw pole assembly and a central axis of the arcuate outer wall of the respective coil facing the lateral casing is parallel to the rotatory shaft; or the respective coil has a planar inner wall facing the respective claw pole assembly and a planar outer wall facing the lateral casing.

As an improvement, each stator assembly of the one or more stator assemblies includes at least three respective solenoids evenly arranged along the circumference of the respective claw pole assembly.

As an improvement, the lateral casing has a cylindrical shape.

As an improvement, the two first claw pole portions include a plurality of first claw poles, the second claw pole portion includes a support body sleeved on the rotor assembly and a plurality of second claw poles arranged on the support body, and the support body is connected to respective iron cores of the respective plurality of solenoids; and each first claw pole of the plurality of first claw poles is located between two respective adjacent second claw poles of the plurality of second claw poles, the plurality of first claw poles and the plurality of second claw poles form a claw pole ring, and the respective plurality of solenoids are arranged on circumference of the claw pole ring.

As an improvement, each first claw pole of the plurality of first claw poles tapers along a direction directing to the support body and includes a respective connection section and a respective extension section bending and extending from the respective connection section towards the plurality of magnetic steels, and each second claw pole of the plurality of second claw poles tapers along a direction far away from the support body.

### Beneficial Effects:

The present disclosure provides a stepper motor, in which the plurality of magnetic steels of the rotor assembly are arranged along circumference of the rotatory shaft, one or more stator assemblies are stacked along the axial direction of the rotor assembly, each stator assembly is sleeved on the rotor assembly, a respective claw pole assembly of each stator assembly is arranged around the circumference of the rotor assembly, a respective plurality of solenoids of each stator assembly are arranged along the circumference of the respective claw pole assembly, the respective housing is configured to accommodate the respective claw pole assembly and the respective plurality of solenoids, a respective coil of each solenoid is wound on a respective iron core, and the central axis of the respective coil extends along the radial direction of the rotatory shaft. Thus, the extension direction of the central axis of the respective coil is the same as the radial direction of the rotatory shaft, the thickness space occupied by the respective coil in the radial direction can be significantly reduced, thereby reducing the radial size of the motor and facilitating achievement of a lightweight and compact motor. Moreover, by flattening the coils, the width space of the motor can be fully utilized, which is conducive to improving the torque performance of the motor. In this way, the radial size of the motor can be reduced, the lightweight and compact motor can be achieved, and the torque performance of the motor can be improved.

### BRIEF DESCRIPTION OF DRAWINGS

In order to illustrate the technical solutions in the embodiments of the present disclosure more clearly, the drawings to be used in the illustration of the embodiments will be briefly described below. It is obvious that the drawings mentioned in the following illustration are only some embodiments of the present disclosure. For those of ordinary skill in the art, other drawings may be obtained in accordance with these drawings without any inventive effort.

FIG. 1 is a schematic diagram of the structure of the stepper motor according to some embodiments of the present disclosure.

FIG. 2 is a schematic diagram of a structure of a housing of the stepper motor according to some embodiments of the present disclosure.

FIG. 3 is a top view of FIG. 2.

FIG. 4 is a cross-sectional view of FIG. 3 taken along the A-A direction.

FIG. 5 is a schematic diagram of a structure of a coil of the stepper motor according to some embodiments of the present disclosure.

FIG. 6 is a side view of FIG. 5.

FIG. 7 is a cross-sectional view of FIG. 6 taken along the B-B direction.

FIG. 8 is a cross-sectional view of some assemblies of the stepper motor according to some embodiments of the present disclosure.

FIG. 9 is a schematic diagram of the structure of the rotatory shaft of the stepper motor according to some embodiments of the present disclosure.

FIG. 10 is a cross-sectional view of FIG. 9 taken along the C-C direction.

### DETAILED DESCRIPTION OF EMBODIMENTS

Embodiments of the present disclosure are illustrated in the following, and examples of the embodiments are shown in the accompanying drawings. In the drawings, the same or similar reference numerals represent the same or similar elements or elements having the same or similar functions. The embodiments illustrated below with reference to the accompanying drawings are exemplary and intended only to explain the present disclosure, and shall not be construed as limiting the present disclosure.

In order for those skilled in the art to better understand the solution of the present disclosure, the technical solution in the embodiments of the present disclosure will be illustrated clearly and completely below in conjunction with the accompanying drawings. Obviously, the illustrated embodiments are only a part of the embodiments of the present disclosure, not all of them. Based on the embodiments in the present disclosure, all other embodiments obtained by those skilled in the art without creative labor fall within the scope of protection of the present disclosure.

In the embodiments of the present disclosure, “at least one” refers to one or more, and “a plurality of” refers to two or more. In the illustration of the present disclosure, the terms “first,” “second,” “third”, and the like are used for the purpose of distinguishing illustration and shall not be understood as indicating or implying relative importance, nor shall be understood as indicating or implying order.

The reference to “one embodiment” or “some embodiments” stated in the specification refers to that specific features, structures, or characteristics described in conjunction with this embodiment are included in one or more embodiments of the present disclosure. Therefore, in the specification, the terms “including”, “containing”, “having” and their variations all refer to “including but not limited to”, unless otherwise specifically emphasized. It should be noted that in the embodiments of the present disclosure, “and/or” describes the association relationship of the associated objects, indicating that there can be three types of relationships. For example, A and/or B may represent: A exists alone, A and B exist simultaneously, and B exists alone.

It is noted that in the embodiments of the present disclosure, when a component is referred to as “fixed to” another component, it may be directly on another component or there may be an intermediate component. When a component is referred to as “connected” to another component, it may be directly connected to another component or there may be an intermediate component. When a component is referred to as “arranged on” another component, it may be directly arranged on another component or there may be an intermediate component. Moreover, in the embodiments of the present disclosure, “connection” may also be understood as electrical connection, and the connection between two electrical components may be a direct or indirect connection between the two electrical components. For example, “A is connected to B” may refer to that A is directly connected to B, or that A is indirectly connected to B via one or more other electrical components. The terms “vertical”, “horizontal”, “left”, ‘right” and similar expressions used in the embodiments of the present disclosure are for illustrative purposes only and are not intended to limit the present disclosure.

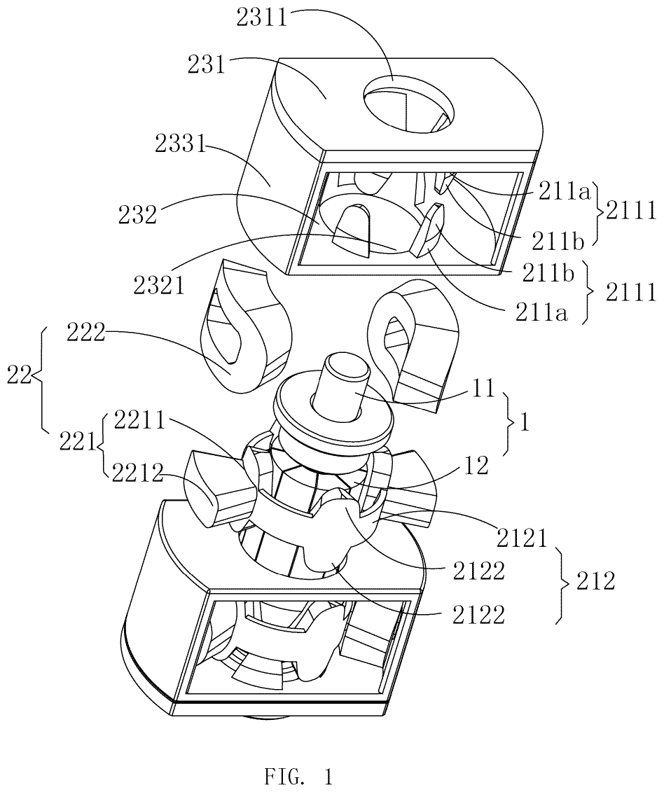

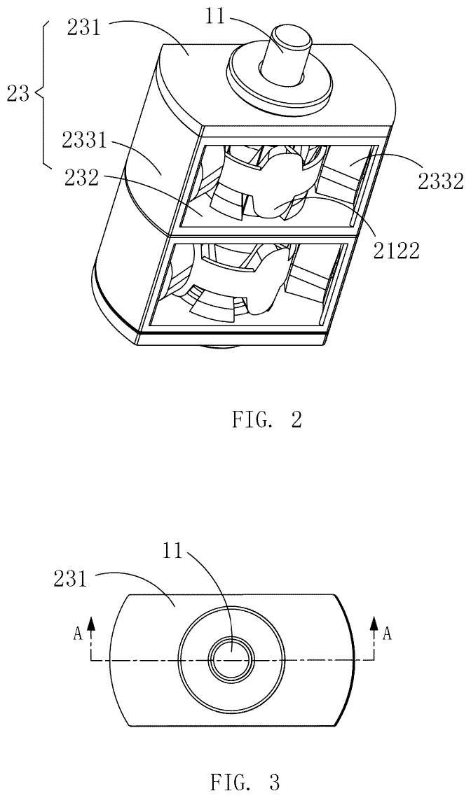

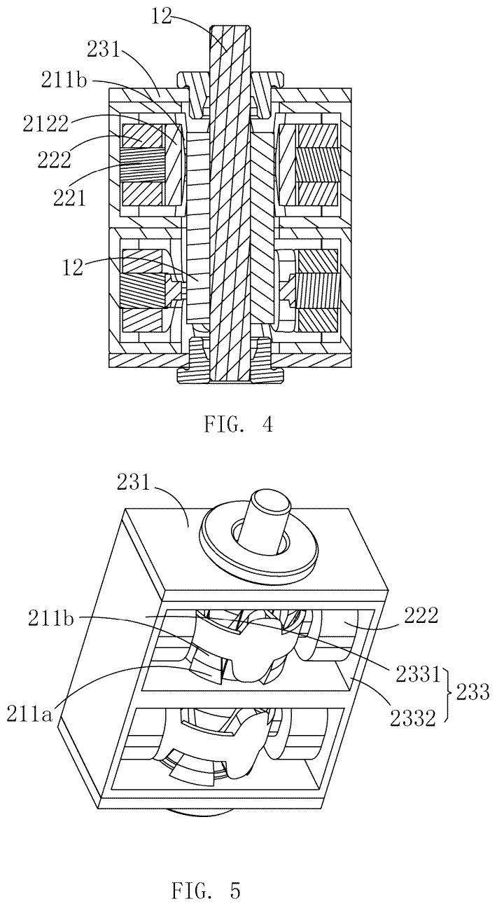

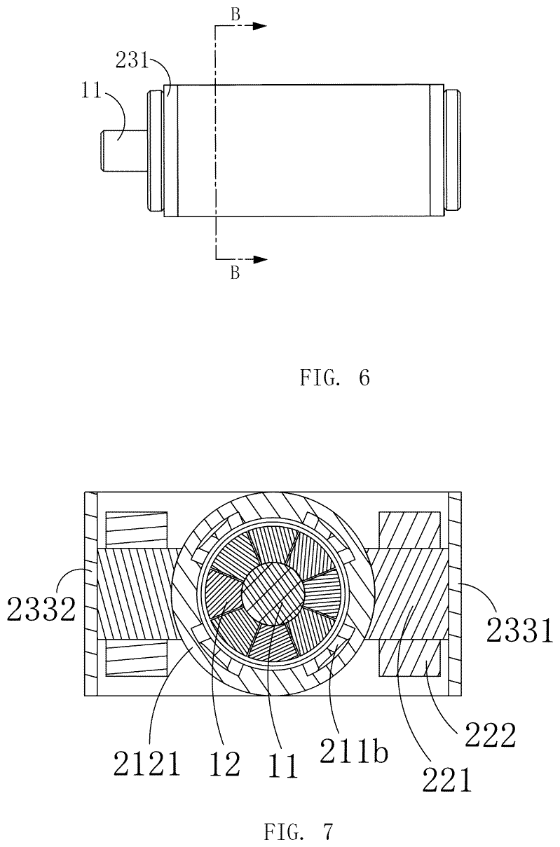

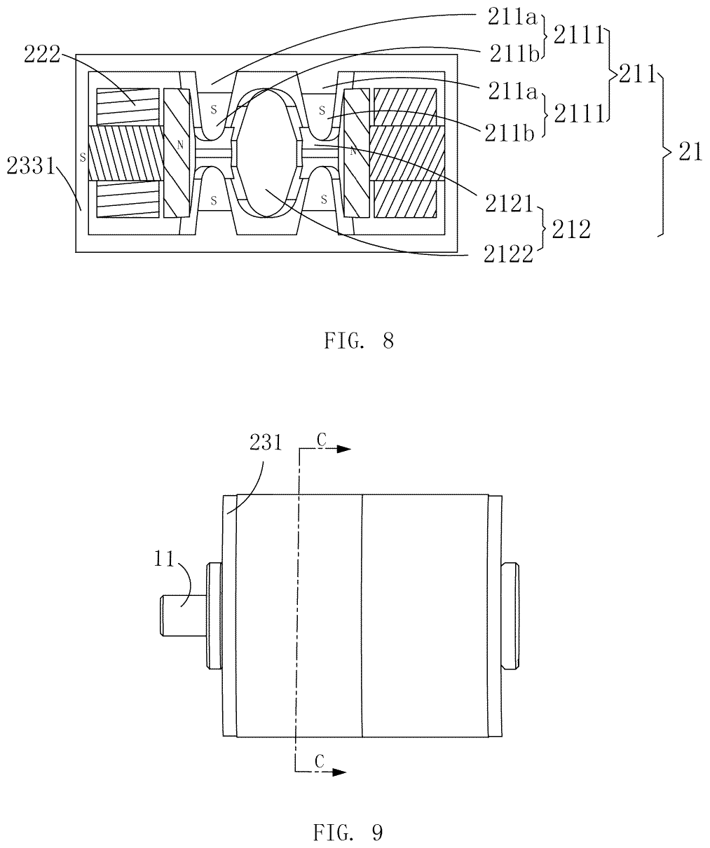

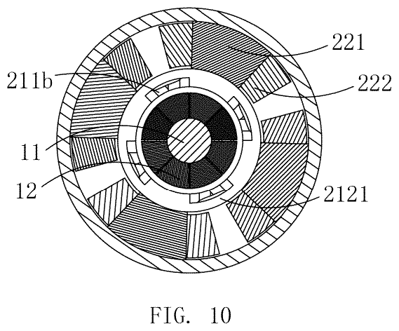

Embodiments of the present disclosure provide a stepper motor, referring to FIGS. 1 to 10, FIG. 1 is a schematic diagram of the structure of the stepper motor according to some embodiments of the present disclosure; FIG. 2 is a schematic diagram of a structure of a housing of the stepper motor according to some embodiments of the present disclosure; FIG. 3 is a top view of FIG. 2; FIG. 4 is a cross-sectional view of FIG. 3 taken along the A-A direction; FIG. 5 is a schematic diagram of a structure of a coil of the stepper motor according to some embodiments of the present disclosure; FIG. 6 is a side view of FIG. 5; FIG. 7 is a cross-sectional view of FIG. 6 taken along the B-B direction; FIG. 8 is a cross-sectional view of some assemblies of the stepper motor according to some embodiments of the present disclosure; FIG. 9 is a schematic diagram of the structure of the rotatory shaft of the stepper motor according to some embodiments of the present disclosure; and FIG. 10 is a cross-sectional view of FIG. 9 taken along the C-C direction. The stepper motor provided in the embodiments of the present disclosure includes a rotor assembly 1 and one or more stator assemblies stacked along an axial direction of the rotor assembly 1, each stator assembly is sleeved on the rotor assembly 1 and includes a respective claw pole assembly 21 arranged around circumference of the rotor assembly 1, a respective plurality of solenoids 22 arranged along circumference of the respective claw pole assembly 21, and a respective housing 23 configured to accommodate the respective claw pole assembly 21 and the respective plurality of solenoids 22. Each solenoid 22 includes a respective iron core 221 and a respective coil 222 wound on the respective iron core 221, and a central axis of the respective coil 222 extends along a radial direction of the rotatory shaft 11.

The respective housing 23 has space for accommodating the plurality of magnetic steels 12, the respective claw pole assembly 21, and the respective plurality of solenoids 22 inside. The plurality of magnetic steels 12 may include two magnetic steels 12, three magnetic steels 12, four magnetic steels 12, five magnetic steels 12, six magnetic steels 12, or the like. For example, when six magnetic steels 12 are provided, these six magnetic steels 12 are symmetrically distributed around the rotatory shaft 11, and after assembling, these six magnetic steels 12 have an overall shape of cylinder. The rotatory shaft 11 runs through the center of the cylinder.

One respective end of each magnetic steel 12 away from the rotatory shaft 11 has magnetism opposite to that of the other respective end close to the rotatory shaft 11. For example, when one end of a magnetic steel 12 close to the rotatory shaft 11 is a magnetic pole of N, then the other end of the magnetic steel 12 away from the rotatory shaft 11 is a magnetic pole of S. Every two adjacent magnetic steels 12 have opposite magnetism at their ends close to the rotatory shaft 11. For example, when an end of a magnetic steel 12 close to the rotatory shaft 11 is a magnetic pole of N, then an end of another magnetic steel 12 adjacent to this magnetic steel 12 close to the rotatory shaft 11 is a magnetic pole of S. Every two adjacent magnetic steels 12 have opposite magnetism at their ends away from the rotatory shaft 11. For example, when an end of a magnetic steel 12 away from the rotatory shaft 11 is a magnetic pole of S, then an end of another magnetic steel 12 adjacent to this magnetic steel 12 away from the rotatory shaft 11 is a magnetic pole of N. The central axis of the respective coil 222 refers to the vertical direction in FIG. 5, the radial direction of the rotatory shaft 11 refers to the vertical direction in FIG. 6, and a radial direction of the motor is the same as the radial direction of the rotatory shaft 11.

In the embodiments, the plurality of magnetic steels 12 of the rotor assembly 1 are arranged along circumference of the rotatory shaft 11, one or more stator assemblies are stacked along the axial direction of the rotor assembly 1, each stator assembly is sleeved on the rotor assembly 1, a respective claw pole assembly 21 of each stator assembly is arranged around the circumference of the rotor assembly 1, a respective plurality of solenoids 22 are arranged along the circumference of the respective claw pole assembly 21, the respective housing 23 is configured to accommodate the respective claw pole assembly 21 and the respective plurality of solenoids 22, a respective coil 222 of each solenoid 22 is wound on a respective iron core 221, and the central axis of the respective coil 222 extends along the radial direction of the rotatory shaft 11. Thus, the extension direction of the central axis of the respective coil 222 is the same as the radial direction of the rotatory shaft 11, the thickness space occupied by the respective coil 222 in the radial direction can be significantly reduced, thereby reducing the radial size of the motor and facilitating achievement of a lightweight and compact motor. Moreover, the width of the respective coil 222 can be adjusted, by flattening the coils 222, the width space of the motor can be fully utilized, which is conducive to improving the torque performance of the motor. In this way, the radial size of the motor can be reduced, the lightweight and compact motor can be achieved, and the torque performance of the motor can be improved.

In some embodiments, the respective claw pole assembly 21 includes two first claw pole portions 211 arranged around the circumference of the rotor assembly 1 and a second claw pole portion 212. One first claw pole portion 211 is connected to the top casing 231 illustrated below, the other first claw pole portion 211 is connected to the bottom casing 232 illustrated below, and the second claw pole portion 212 is arranged between the two first claw pole portions 211. The second claw pole portion 212 is arranged around the circumference of the rotor assembly 1, and the two first claw pole portions 211 are connected to the respective housing 23. The respective iron core 221 has a first end 2211 in contact with the second claw pole portion 212 and a second end 2212 opposite to the first end 2211 and in contact with an inner wall of the respective housing 23. The iron cores 221 can enhance the generation capability of magnetic field of the solenoids 22, such that the motor can generate greater torque under the same current. Moreover, by connecting the iron cores 221 to the second claw pole portions 212 and the housings 23, the stable fixation of the solenoids 22 inside the motor can be ensured, thereby reducing the vibration and noise of the motor during rotation.

In some embodiments, the respective housing 23 includes a top casing 231 and a bottom casing 232 arranged opposite to each other and further includes a lateral casing 233 connecting the top casing 231 and the bottom casing 232. A top central hole 2311 configured for passing through by the rotor assembly 1 is defined on the top casing 231, a bottom central hole 2321 configured for passing through by the rotor assembly 1 is defined on the bottom casing 232, one of the two first claw pole portions 211 is connected to an inner periphery of the top central hole 2311, and the other of the two first claw pole portions 211 is connected to an inner periphery of the bottom central hole 2321. The top casing 231, the bottom casing 232, and the lateral casing 233 also may be integrally formed.

In some embodiments, the lateral casing 233 may include a first lateral casing 2331 and a second lateral casing 2332 arranged opposite to each other, one of the two respective solenoids 22 is connected to the first lateral casing 2331, and the other of the two respective solenoids 22 is connected to the second lateral casing 2332. In this case, each of an outer wall of the first lateral casing 2331 and an outer wall of the second lateral casing 2332 is planar, or each of the outer wall of the first lateral casing 2331 and the outer wall of the second lateral casing 2332 is arcuate. When the two respective solenoids 22 are provided, these two respective solenoids 22 are arranged to be in axial symmetry relative to the rotatory shaft 11.

In some embodiments, the respective coil 222 of each solenoid 22 has an arcuate inner wall facing the respective claw pole assembly 21 and an arcuate outer wall facing the lateral casing 233, and each of a central axis of the arcuate inner wall of the respective coil 222 facing the respective claw pole assembly 21 and a central axis of the arcuate outer wall of the respective coil 222 facing the lateral casing 233 is parallel to the rotatory shaft 11. In this case, the outer wall of the first lateral casing 2331 and the outer wall of the second lateral casing 2332 are both arcuate. Alternatively, referring to FIG. 5, the respective coil 222 has a planar inner wall facing the respective claw pole assembly 21 and a planar outer wall facing the lateral casing 233. In this case, the inner wall of the first lateral casing 2331 and the inner wall of the second lateral casing 2332 are both planar, and the outer wall of the first lateral casing 2331 and the outer wall of the second lateral casing 2332 also are both planar. In this way, the motor can have a relatively small radial size, and can adapt relatively small overall space.

In some embodiments, referring to FIGS. 6 and 7, the lateral casing 233 has a cylindrical structure. In this case, each stator assembly may include at least three respective solenoids 22 evenly arranged along the circumference of the respective claw pole assembly 21. For example, each stator assembly may include three, four, five or six respective solenoids 22, and the six respective solenoids 22 may be evenly arranged along the circumference of the respective claw pole assembly 21.

In some embodiments, the respective plurality of solenoids 22 generate a magnetic pole at the second claw pole portion 212 has magnetism opposite to that of a magnetic pole generated by the respective plurality of solenoids 22 at the two first claw pole portions 211. For example, when current runs through the respective coil 222 of each solenoid 22, N and S magnetic poles will be generated at both ends of the respective iron core 221, respectively. The end at which the N magnetic pole is generated is directly connected to the second claw pole portion 212, causing the second claw pole portion 212 to have magnetism of N. The end at which the S magnetic pole is generated is connected to the two first claw pole portions 211 via the housing 23, causing the two first claw pole portions 211 to have magnetism of S. Alternatively, S and N magnetic poles will be generated at both ends of the respective iron core 221, respectively. The end at which the S magnetic pole is generated is directly connected to the second claw pole portion 212, causing the second claw pole portion 212 to have magnetism of S. The end at which the N magnetic pole is generated is connected to the two first claw pole portions 211 via the housing 23, causing the two first claw pole portions 211 to have magnetism of N. In this way, the polarity of the second claw pole portion 212 and the two first claw pole portions 211 is distributed alternatively, thereby actuating the plurality of magnetic steels 12 and the rotatory shaft 11 to rotate.

In some embodiments, the two first claw pole portions 211 include a plurality of first claw poles 2111, the second claw pole portion 212 includes a support body 2121 sleeved on the rotor assembly 1 and a plurality of second claw poles 2122 arranged on the support body 2121, and the support body 2121 is connected to respective iron cores 221 of the respective plurality of solenoids 22. Each first claw pole 2111 is located between two respective adjacent second claw poles 2122, the plurality of first claw poles 2111 and the plurality of second claw poles 2122 form a claw pole ring, and the respective plurality of solenoids 22 are arranged on circumference of the claw pole ring. By arranging the plurality of first claw poles 2111 and the plurality of second claw poles 2122 alternatively, the respective claw pole assembly 21 can have improved uniformity of magnetic field distribution around the circumference of the rotatory shaft 11, which is conducive to improving the stability of torque output of the stepper motor. Moreover, the respective plurality of solenoids 22 are arranged on the circumference of the claw pole ring, in this way, the width space of the motor can be utilized more effectively, thereby further improving the torque performance, and achieving a reduction in the radial size.

In some embodiments, each first claw pole of the plurality of first claw poles 2111 tapers along a direction directing to the support body 2121, and each second claw pole of the plurality of second claw poles 2122 tapers along a direction far away from the support body 2121. The tapered first claw poles 2111 and the tapered second claw poles 2122 can enable the claw pole assemblies 21 to have improved concentration of magnetic field in the radial direction of the motor, which is conducive to enhancing the magnetic field coupling between the claw pole assemblies 21 and the plurality of magnetic steels 12, thereby improving the torque performance of the stepper motor.

In some embodiments, each first claw pole 2111 includes a respective connection section 211a and a respective extension section 211b bending and extending from the respective connection section 211a towards the plurality of magnetic steels 12. In other words, space for accommodating the respective extension section 211b is left between the support body 2121 and the plurality of magnetic steels 12, and at least a portion of the respective extension section 211b extends into the space between the support body 2121 and the plurality of magnetic steels 12. Furthermore, the respective extension section 211b bends towards the plurality of magnetic steels 12, which is conducive to reducing the radial size of the motor, thereby achieving the lightweight and compact motor.

It is noted that the above embodiments are only used to illustrate the technical solution of the present disclosure and not to limit it. Although the present disclosure has been illustrated in detail with reference to examples, those of ordinary skill in the art shall understand that the technical solution of the present disclosure may be modified or equivalently substituted without departing from the spirit and scope of the technical solution of the present disclosure, which also falls in the scope of the claims of the present disclosure.

What is claimed is:

1. A stepper motor, comprising:
a rotor assembly including a rotatory shaft and a plurality of magnetic steels arranged along circumference of the rotatory shaft; and
one or more stator assemblies stacked along an axial direction of the rotor assembly, wherein each stator assembly of the one or more stator assemblies is sleeved on the rotor assembly and includes a respective claw pole assembly arranged around circumference of the rotor assembly, a respective plurality of solenoids arranged along circumference of the respective claw pole assembly, and a respective housing configured to accommodate the respective claw pole assembly and the respective plurality of solenoids, and wherein each solenoid of the respective plurality of solenoids includes a respective iron core and a respective coil wound on the respective iron core, and a central axis of the respective coil extends along a radial direction of the rotatory shaft.

2. The stepper motor according to claim 1, wherein the respective claw pole assembly includes two first claw pole portions arranged around the circumference of the rotor assembly and a second claw pole portion arranged around the circumference of the rotor assembly, the second claw pole portion is arranged between the two first claw pole portions, and the two first claw pole portions are connected to the respective housing; and
wherein the respective iron core has a first end in contact with the second claw pole portion and a second end in contact with an inner wall of the respective housing.

3. The stepper motor according to claim 2, wherein the respective housing includes a top casing and a bottom casing arranged opposite to each other and further includes a lateral casing connecting the top casing and the bottom casing, and wherein a top central hole configured for passing through by the rotor assembly is defined on the top casing, a bottom central hole configured for passing through by the rotor assembly is defined on the bottom casing, one of the two first claw pole portions is connected to an inner periphery of the top central hole, and an other of the two first claw pole portions is connected to an inner periphery of the bottom central hole.

4. The stepper motor according to claim 3, wherein each stator assembly of the one or more stator assemblies includes two respective solenoids arranged to be in axial symmetry relative to the rotatory shaft.

5. The stepper motor according to claim 4, wherein the lateral casing includes a first lateral casing and a second lateral casing arranged opposite to each other, one of the two respective solenoids is connected to the first lateral casing, and an other of the two respective solenoids is connected to the second lateral casing; and
wherein each of an outer wall of the first lateral casing and an outer wall of the second lateral casing is planar or arcuate.

6. The stepper motor according to claim 3, wherein the respective coil has an arcuate inner wall facing the respective claw pole assembly and an arcuate outer wall facing the lateral casing, and each of a central axis of the arcuate inner wall of the respective coil facing the respective claw pole assembly and a central axis of the arcuate outer wall of the respective coil facing the lateral casing is parallel to the rotatory shaft; or
wherein the respective coil has a planar inner wall facing the respective claw pole assembly and a planar outer wall facing the lateral casing.

7. The stepper motor according to claim 3, wherein each stator assembly of the one or more stator assemblies includes at least three respective solenoids evenly arranged along the circumference of the respective claw pole assembly.

8. The stepper motor according to claim 7, wherein the lateral casing has a cylindrical shape.

9. The stepper motor according to claim 2, wherein the two first claw pole portions include a plurality of first claw poles, the second claw pole portion includes a support body sleeved on the rotor assembly and a plurality of second claw poles arranged on the support body, and the support body is connected to respective iron cores of the respective plurality of solenoids; and
wherein each first claw pole of the plurality of first claw poles is located between two respective adjacent second claw poles of the plurality of second claw poles, the plurality of first claw poles and the plurality of second claw poles form a claw pole ring, and the respective plurality of solenoids are arranged on circumference of the claw pole ring.

10. The stepper motor according to claim 9, wherein each first claw pole of the plurality of first claw poles tapers along a direction directing to the support body and includes a respective connection section and a respective extension section bending and extending from the respective connection section towards the plurality of magnetic steels, and each second claw pole of the plurality of second claw poles tapers along a direction far away from the support body.
